(19) United States
(12) Patent Application Publication
(10) Pub. No.: US 2009/0056518 A1
(43) Pub. Date: Mar. 5, 2009

(54) Plastic miter block with saw blade guide

(76) Inventor: Mitchell D. Stein, Burbank, CA (US)

Correspondence Address: Mitchell Dewain Stein, 712 Groton Drive, Burbank, CA, 91504, US

(21) Appl. No.: 11/895,760

(22) Filed: Aug. 27, 2007

(51) Int. Cl. B26D 7/01

(52) U.S. Cl. 83/743

(57) ABSTRACT

The present invention supports masonry pieces during cutting in order to obtain 45 and 22.5 degree angles. The present invention further encompasses a method and material for manufacture that being injection-molded plastic, so the invention is waterproof and harmless to modern diamond saw blades. The method for using the invention is in combination with a table style wet saw, in particular, one using a roller tray with lip or one that guides motor and the blade across a stationary tray with lip. The size and dimensions of the invention are worked out for the greatest number of uses in the widest variety of applications. The present invention method incorporates a slot to be used as a saw blade guide. One skilled in the art will find this device is capable of quickly and safely supporting masonry pieces for inside and outside 45 and 22.5 degree cuts, namely miters. Primarily this device is intended to be used with standard masonry wet saws. It is conceivable that this device would be helpful at a multitude of other tasks, where support and miter angles are a part of the work process.

### BACKGROUND OF THE INVENTION

The most common wet saw consists of a diamond saw blade rotating about a horizontal axis with a reservoir pan being located beneath the saw blade for retaining a Coolant which is continuously pumped from the reservoir onto the saw blade while the saw blade is in use. A sliding platform or table mounts on tracks directly within their resident reservoir providing for moving a work piece underneath the circular saw Blade. Such a construction is shown in U.S. Pat. No. 3,635,206 issued Jan. 18, 1972 to HARCLEROGE. More modern wet saws, especially those with smaller diamond blades, try moving the motor with blade attached over the material to be cut, while leaving the platform stationery. Still, the platform must be kept stationery and flat because of the coolant reservoir directly beneath as in a drip pan. Unlike conventional saws, the sliding tray of most Mason's wet saw cannot be permitted to have any angle adjustments relative to the saw blade. This is required because the mounting tracks, on which the platform slides are, as described above, located directly in the cooling reservoir, which would spill its contents if tipped out of the horizontal plane. Therefore, because the platform is not adjustable, a separate miter guide attachment must be provided on the platform. There are those that do have platforms in which a section can be tilted, primarily, only for cutting a miter on a flat tile edge and are of little to no use in cutting radius or odd shaped masonry products. There exists a need for our quick, safe consistent platform to assist in cutting miters on ceramic radius edge trim tiles. Radius edge trim tiles and caps are frequently used as decorative trim and edge pieces in many modern ceramic and Masonry installations. One of the more difficult challenges a tile mason faces is the consistent cutting of 45 and 22.5 degree angles in order to make smooth joints and transitions around the corners and in other locations, as well as with common decorative trim patterns. This problem is exasperated when using radius tile caps, chair rails, ropes, crowns, base, and many others. These styles are much more difficult to lay on a smooth flat surface to use with a standard table style cutting blade. While substantial art exists for measuring tiled cuts and even for drawing complex angles. This art is often complex and does not address the basic need for 45 and 22.5 degree angles, as well as a holding the tile/radius edge trim pieces to be cut in a quick safe fashion.
A common answer to this problem among Mason's is to cut these angles from 2×4 and 2×6 inch lumber. Wood is not the ideal material to be used around modern diamond saw blades for a number of reasons, among these reasons is size, in particular, the width of the 2×4 or 2×6 is typically 1.75″. This height is not high enough of a platform to support V-cap pieces at a proper height to the sliding platform. Another drawback to this solution is a ¼″ radius edge that allows for a tight and square platform for tile V cap piece fit while making these complex cuts. The practice of making these wooden angles, demands, separate wooden block pieces for 45 and 22.5 degree angles. The president convention substantially departs from the conventional solutions. Namely wooden angles, and designs of prior art. In doing so provides standard tile saws an accessory that assists in the safe, precise miter cutting of radius edge masonry trims and tile cap pieces.
One of the solutions for this problem is shown in the example U.S. Pat. No. 6,082,723 Matthews, who shows a base for cutting 45° angles on standard bull nose tile cap. The patent does not disclose the type of material; said base is to be manufactured of. Neither does it allow for other types of trim masonry pieces, such as V cap nor 22.5 degree angle miter cuts.

The ornamental design for a multi-angle tile saw miter guide as shown in U.S. Pat. D 481,603. Kelly. Shows a block like platform to be used as an accessory to a wet saw in the function of cutting tile V cap. Kelly states, prior art as FTS—150 portable production tile saw and cutting accessories described on page 12 of the Felker full-line products catalog, 11th edition, which may be considered prior art relative to the instant application. www.Felkersaws.com. The design patent makes no mention of dimensions or method and materials of manufacture. This design does not allow for a saw blade guide, allowing the saw blade to cut radius material safely and without harming diamond blade.

### SUMMARY OF THE INVENTION

Other devices may exist in the art for actual tile cutting but these devices also provide a more complex method for cutting variable angles and involve complex table size components with the concurrent increased expense and increase bulkiness and increased complexity that such matters would provide. Therefore, it can be appreciated that there exists a need in the art for a waterproof, light weight, durable and inexpensive wet saw accessory composed of a material that will not harm the expensive diamond saw blade and of the dimensions best suited the widest variety of materials to be miter cuts on standard tile saws. The plastic “miter block with saw blade guide” will aid in the precise safe, cutting of multiple angles on a wide variety of masonry trim and radius cap pieces. The inventions intended usefulness has evolved over years of necessity and research by trial and error while the inventor worked as a mason in the tile arts.

### BRIEF DESCRIPTION OF THE DRAWINGS

FIG. 1 is an Isometric Projection of the invention known as, Plastic Miter Block with Saw Blade Guide. This view visually conveys the overall shape, and is suitable for posting in the Official Gazette.

FIG. 2 is the Top view of the invention, this view is showing radius corners.

FIG. 3 is the Top Left Side view of the invention.

FIG. 4 is the Front view of the invention, this view is showing saw blade guide slot.

FIG. 5 is the Top Right Side view of the invention.

FIG. 6 is the Bottom view of the invention, this view is showing hollow interior cavity separated by support ribs.

FIG. 7 is the Rear view of the invention.

FIG. 8 is the Top view of the invention, this view is showing dimensions for width, length and typical radius corners.

FIG. 9 is the Front view of the invention, this view is showing the 45 and 22.5 degree angles.

FIG. 10 is an Isometric Projection of the invention depicting the usual environment, this view is showing the invention in position for cutting a 22.5 degree miter on a table style, rotary diamond blade, fluid cooled, masonry saw.

### DETAILED DESCRIPTION OF THE INVENTION

A known masonry saw as described in U.S. Pat. No. 3,635,206 includes a saw blade (2) rotating about a horizontal axis, a coolant containing reservoir and a sliding platform or table with curb (3). The problems encountered while cutting certain miters are well described in U.S. Pat. No. 4,315,494. As well as U.S. Pat. No. 6,082,723. The present invention dramatically simplifies the problem of miter cutting on radius edged masonry products. While the invention (1) may also be used to cut a wide variety of masonry products, for the purpose of the preferred embodiment, the cutting of ceramic tile V-cap (4), using a standard masonry wet saw will be addressed. One skilled in the art will recognize that many of the functions for cutting a wide variety of miter cuts will be equally applicable to cutting masonry products generally. The tile cap (4) may be placed in any of numerous orientations allowing for various dimensions of the tile cap (4) to be cut at the predefined dimensions by simply aliening the saw guide (5) of the invention with the saw blade (2) then pushing the table with curb (3) and the invention (1) with tile cap (4) forward along table carrying the desired portion of the tile Through the cutting blade (2) at the desired angle either 22.5 (6) or 45 degree (7). The invention (1) is to be made of injection molded plastic so as to not harm the expensive diamond saw blade (2). FIG. 5 illustrates a view looking straight down to demonstrate the invention (1) at work, with the usual environment of the invention, showing the bottom of the invention (1) abutting the vertical saw table curb (3) that is reflected by two horizontal phantom lines (3) and extending parallel to the bottom of the invention (1) The top of the invention (1) is shown supporting a piece of tile cap (4) that is depicted by rectangular phantom lines extending inclined to the tile saw table curb (3) by a 22.5 degree (6) angle to the tile saw blade (2) that is depicted by two horizontal solid lines extending perpendicular to the tile saw table curb (3) in a position the blade occupies (8) both before and after making a miter cut on a single peace of the tile V-cap (4).

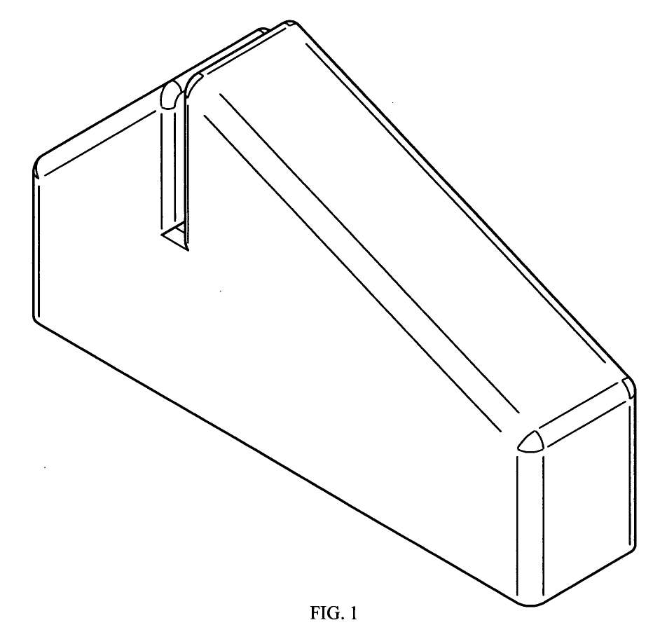

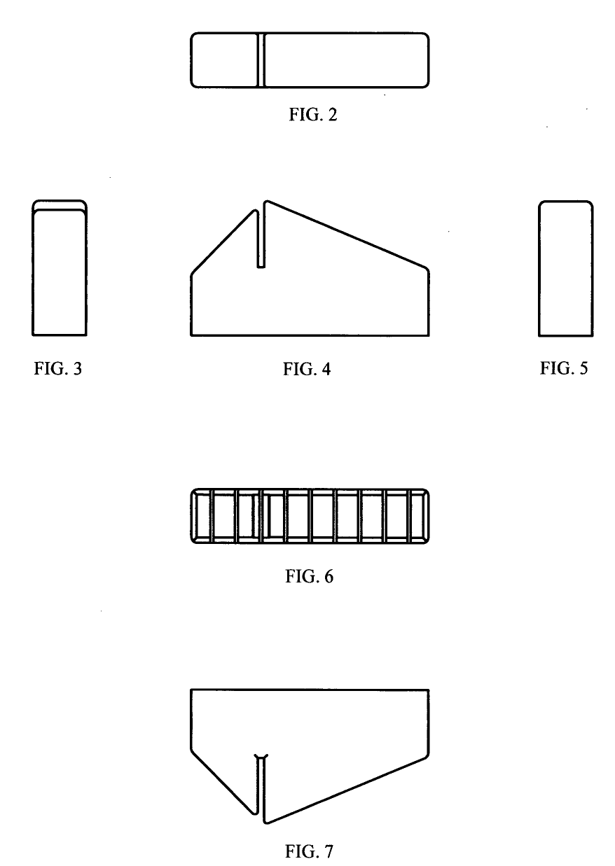

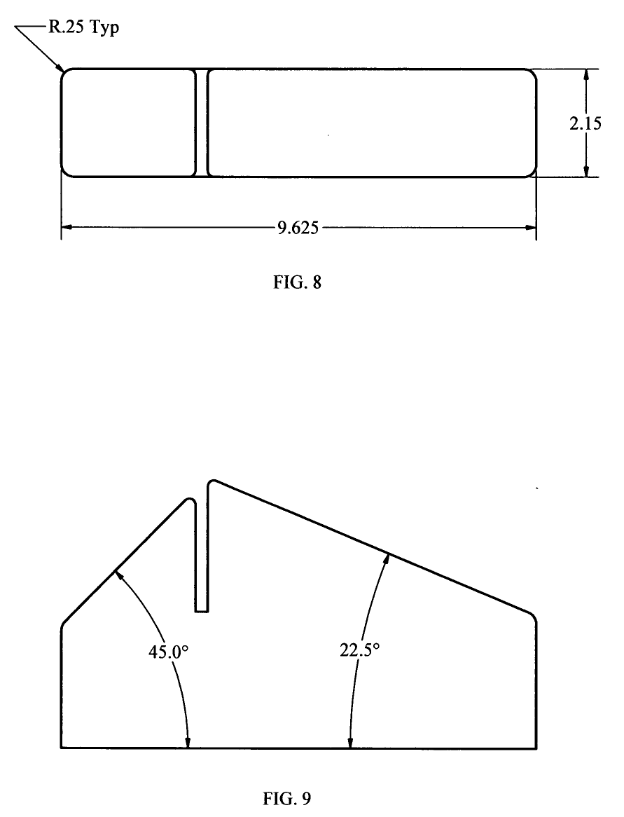

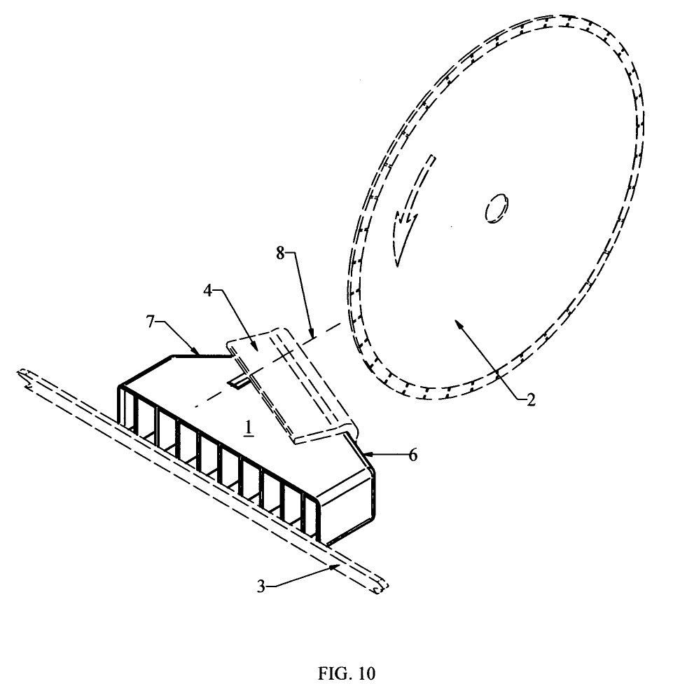

In summary the invention uses the elements of simple 45 (7) and 22.5 degree (6) angles separated by a slot known as a saw guide (5) built to the dimensions that would best be used with a standard 10 inch blade (2) tile saw and for cutting common tile cap (4). The invention (1) would be made of injection molded plastic materials that do not harm expensive diamond masonry saw blades (2) and is not affected by the wet conditions of work environment produced by the coolant used by the pre-described tile saws. The invention (1) consists of a hollow body with support ribs as shown in cutaway views FIG. 1 and FIG. 3 for weight and strength. The invention (1), a block like platform, provides a water proof, stable, flat and square surfaces to facilitate miter cuts on a wide variety of masonry products. The simplicity of this system cannot be overstated in regards to speed, safety and accuracy.

What is claimed is:

1. A portable miter guide platform for use with a masonry saw, said miter guide platform comprising two reversible work piece receiving faces, one 45 degree work piece receiving face and one 22.5 degree work piece receiving face separated by a notch/slot to be used as a saw blade guide, said miter guide platform is to be placed upon saw table with work piece receiving faces at their perspective angles to saw blade.

2. A portable miter guide platform as claimed in claim 1, is reversible in that it has two symmetrical side faces, so that when flip over left miters become rights and right miters become left.

3. A portable miter guide platform as claimed in claim 1, dimensions are that the two symmetrical side faces which are at a 90 degree angle to all other faces are parallel by the dimensions of or near 2⅛ inches.
